(19) United States
(12) Patent Application Publication
(10) Pub. No.: US 2017/0307131 A1
(43) Pub. Date: Oct. 26, 2017

(54) UTILITY SUPPORT

(71) Applicant: KETER PLASTIC LTD., Herzelyia (IL)

(72) Inventor: Yaron BRUNNER, Kibbutz Gvat (IL)

(73) Assignee: KETER PLASTIC LTD., Herzelyia (IL)

(21) Appl. No.: 15/517,366

(22) PCT Filed: Oct. 6, 2015
(86) PCT No.: PCT/IL2015/050988

§ 371 Date: Apr. 6, 2017

Related U.S. Application Data
(60) Provisional application No. 62/060,149, filed on Oct. 6, 2014.

(51) Int. Cl. F16M 11/22; E04H 12/22; B25H 1/00; E01F 9/654; A47C 7/00; E01F 9/658; F16M 13/02; B27B 21/00

(52) U.S. Cl. CPC F16M 11/22; F16M 13/02; E04H 12/2238; B27B 21/00; E01F 9/654; A47C 7/002; E01F 9/658; B25H 1/0042

(57) ABSTRACT

Provided is a utility support. The utility support may include a bottom base with a tapering side wall extending therefrom towards a top base. Additionally, the utility support may be hollow. Further, at least one of the side wall, the bottom base and the top base may be configured with at least one utility portion.

### TECHNOLOGICAL FIELD

The presently disclosed subject matter is generally in the field of DIY (do it yourself) tools, and more particularly it is concerned with a support structure for serving at different utility configurations.

### BACKGROUND ART

References considered to be relevant as background to the presently disclosed subject matter are listed below:
US2004079587
US2006103176
US2013105338

Acknowledgement of the above references herein is not to be inferred as meaning that these are in any way relevant to the patentability of the presently disclosed subject matter.

### BACKGROUND

Various types of DYI support structures are known in the art. Some of these are acknowledged herein as follows:

The US2004079587A is directed to a raised platform which includes at least two pails, a board, and two brackets for securing a bottom of the top pails to opposing ends of the board. The buckets and board are commonly found at construction sites. The brackets are particularly low-cost and easily transported such that they are basically a throwaway item that can easily be carried to job sites by a construction worker. With minimal effort and using self-tapping screws or other mechanical fasteners, the raised platform can be easily quickly constructed, used, and disposed of without consuming worker time in an inefficient manner.

The US2006103176A is directed to a portable seating device is provided in the form of at least two horizontal planks having respective coupling ends along which such members may be joined. The underside surfaces of these planks are provided with vertical support containment means. Such vertical support containment means serve to contain and localize the upper end of a central vertical support placed against the underside surfaces of the two horizontal seating members, overlapping their connected coupling ends. A preferred central vertical support is a tapered pail or bucket which may or may not have its carrying handle removed. Additional vertical supports may be provided to underlie further portions of the underside surfaces of the horizontal planks, deployed symmetrically on either side of the central vertical support and similarly localized against the underside surfaces.

The US2013105338A is directed to a container having a dual use as a receptacle for debris that can accommodate a sawhorse application. Square or U-shaped recesses are located in the rim of the container for securing a sawhorse support, such as a board, Sawhorse supports are friction fit, or securely mounted to the container by pin, screw, nail, or bolt attachment. A lid having a slotted structure for receiving a sawhorse support may be used to transform a common household container into a sawhorse.

### GENERAL DESCRIPTION

The present disclosure is directed to a utility support comprising a bottom base with a tapering side wall extending therefrom towards a top base, wherein said utility support is hollow and configured for nestable stacking over like utility supports, and further wherein at least one of said side wall, said bottom base and said top base is configured with at least one utility portion.

According to a one aspect of the presently disclosed subject matter, the utility support can be configured for use in conjunction with a container, said utility support having a bottom base with side walls extending therefrom, whereby the bottom base of the utility support is configured for mounting over the top edge of said container.

According to another aspect of the presently disclosed subject matter, the utility support is a configured for use at a stand-alone configuration, with the bottom base supported on a ground surface.

Any one or more of the following designs, features and configurations can be applied with the utility support of the present disclosure, separately or in various combinations thereof:
A bottom face of the bottom base can be configured with a container mounting portion;
The bottom base and the top base can be coaxial along a longitudinal axis of the utility support;
The bottom base can be configured with a mounting portion for mounting over a top edge of a container;
The bottom base can be polygonal or circular;
The top base can be polygonal or circular;
The utility support can be of a variety of polyhedron shapes;
The tapering side wall can be continues or interrupted, with one or more aperture;
The tapering side wall can be solid or can be defined by side posts extending between said bottom base and said top base;
The side walls and the side posts can be configured with reinforcing ribs or longitudinally extending bends, thus increasing yield strength of the utility support, at least in the axial direction along the longitudinal axis;
The side walls and the side posts can be configured with longitudinally extending bends having a bottom end and an open top end, said top end being wider than said bottom end;
The utility support can be made of molded plastic material;
The bottom base can be continuous or it can be interrupted;
The utility portion can be any one or more of the following:
   A notch configured to hold an object therein (in any desired cross section, e.g. a v-notch, a U-notch or other cross section);
   A saw horse with a V-notch (or other cross-section);
   A beam support, whereby one or more beams or rods can be connected to or extend from the utility support. Said beam support can be on the top base and/or through side walls;
   A beam support can have side walls configured for supporting a rectangular beam at an upright orientation;
   Fence or barrier supports;
   Table or other surface support;
   Work bench;
   Scaffold support;
   Pole support (e.g. as a road sign, flag, etc.);
   Traffic cone with or without signs;
   The utility portion can be configured for articulation thereto of one or more beams by fasteners;
   The utility portion can be configured with a clamp coupling portion for clamping articles thereto;
   The utility portion can be configured with hooks, e.g. for articulating a chain thereto or hanging articles thereon;
   The utility portion can be configured with one or more tying ports;
   The utility portion can a seating surface configured at the top base;
   The top base can be configured with an anti slip portion;
   The utility support can be configured with illumination and/or light reflective material;
   The utility portion can be configured with one or more compartments, optionally closable, e.g. for use as an organizer;
   The utility support can be configured with a fixation arrangement for fixing to a ground surface;
   The bottom base of the utility support can be configured with a fixing arrangement for securing same to a top edge of a container;
   The utility support can be used in conjunction with a 5 gallon container/bucket, wherein said bottom base is configured for mounting over a top rim of said 5 gallon container;
   The utility support can be configured with a carrying arrangement such as a gripping portion, aperture, hook etc.;
When used in conjunction with a container, i.e. when the bottom base is mounted over the top edge of the container, openings at the side wall of the utility support facilitate accessibility into the interior of the container/bucket;
The bottom base can be configured with a dual position mounting portion, configured for mounting the utility support over a top edge of a container at an upright position, i.e. with the top base extending above the bottom base, or at a bottoms-up position, i.e. with the top base extending into the interior of the container (below the bottom base);
The dual position mounting portion of the bottom base can have a T-like cross-section;
When disposed at the bottoms-up position a cover can be articulated over a bottom edge of the bottom base, thereby serving as a cover for the container and optionally as a seat;
The bottom edge of the bottom base can be configured with notches (e.g. V-like or otherwise shaped notches) there facilitating it for use as a saw horse.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a perspective view of a utility support according to a first aspect of the presently disclosed subject matter;

FIG. 2A is a top perspective view of a top base of the utility support of FIG. 1;

FIG. 2B is perspective view of a utility support fitted with reflective portions;

FIG. 3A is a perspective view of several utility supports as of FIG. 1, nestably stacked;

FIG. 3B is a longitudinal section along line III-III in FIG. 3A;

FIG. 3C is a perspective bottom view of a portion of FIG. 3A;

FIGS. 4A to 4F illustrate different modes of use of the utility support of FIG. 1;

FIG. 5 is an isometric view of several nestably stacked utility supports, according to a different design of the first aspect;

FIG. 6A is a perspective view of a utility support according to a second aspect of the presently disclosed subject matter;

FIG. 6B is a longitudinal section along line VI-VI in FIG. 6A;

FIG. 7 is a perspective view of several utility supports as of FIG. 6A nestably stacked;

FIG. 8 is a side view of several utility supports as of FIG. 6 nestably stacked, and corresponding 5-gallon containers for use in conjunction therewith;

FIG. 9A illustrates mounting a utility support over a container;

FIG. 9B is a perspective view of the assembly of FIG. 9A;

FIG. 9C is a longitudinal section along line IX-IX in FIG. 9B;

FIG. 9D is an enlargement of the portion marked ‘A’ in FIG. 9C;

FIG. 9E is a longitudinal planer section of the utility support of FIG. 6A mounted over an inverted 5-gallon container;

FIG. 10 illustrates different modes of use of the utility support of FIG. 6A;

FIG. 11 is a perspective view of a utility support according to another example of the disclosure;

FIG. 12A is a perspective view of several utility supports as of FIG. 11, nestably stacked;

FIG. 12B is a longitudinal section along line XI-XI in FIG. 12A;

FIG. 13 is a top perspective view of the utility support of FIG. 11;

FIGS. 14A to 14E are several enlarged portions of the utility support of FIG. 111;

FIGS. 15A to 15D illustrate different modes of use of the utility support of FIG. 11;

FIG. 16A is a perspective view of a utility support according to a modification of the second aspect of the present disclosure;

FIG. 16B is a section along line XV-XV in FIG. 16A;

FIG. 16C is an enlargement of the portion marked ‘B’ in FIG. 16B;

FIG. 17 illustrates mounting the utility support of FIG. 16A over a container, at an upright position;

FIG. 18 illustrates mounting the utility support of FIG. 15A at a bottoms-up position;

FIG. 19A is a longitudinal section of a three-level assembly comprising two utility supports and an intermediate 5-gallon container; and

FIG. 19B is an enlargement of the portion marked ‘C’ in FIG. 19A.

### DETAILED DESCRIPTION OF EMBODIMENTS

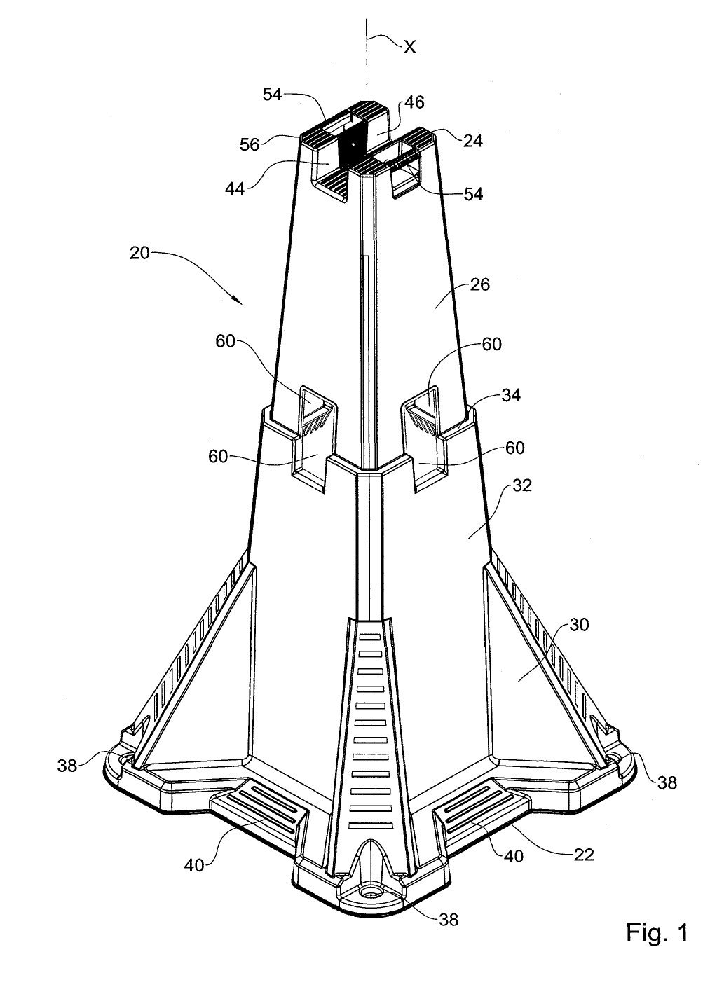

Attention is first directed to FIGS. 1 to 5 directed to a utility support according a first aspect of the present disclosure.

The utility support illustrated in FIGS. 1 to 4 is generally designated 20 and is typically made of molded plastic material. Optionally different additives can be added such as UV repellant, reinforcing fibers, light reflecting additives and the like. The utility support can comprises one or more portions of composite material, e.g. anti-slip portions, reflective material, etc.

The structure of the utility support 20 is rigid, i.e. non-deformable and durable, designed to bear loads, in particular loads applied in an axial (vertical) direction, as will be discussed hereinafter.

The utility support 20 has a general shape of a hollow frustum rectangle pyramid, extending between a bottom base 22 and a top base 24, with enveloping, tapering side walls 26, extending coaxial about a longitudinal axis X. The structure of the utility support 20 is reinforced by the provision of reinforcing corner ribs 30 and a thickened wall at a bottom portion 32 (narrowing at line 34). It is appreciated that whilst in the present example the utility support has a rectangle cross-section, other designs can be utilized, e.g. circular, polygonal or complex (combined) designs.

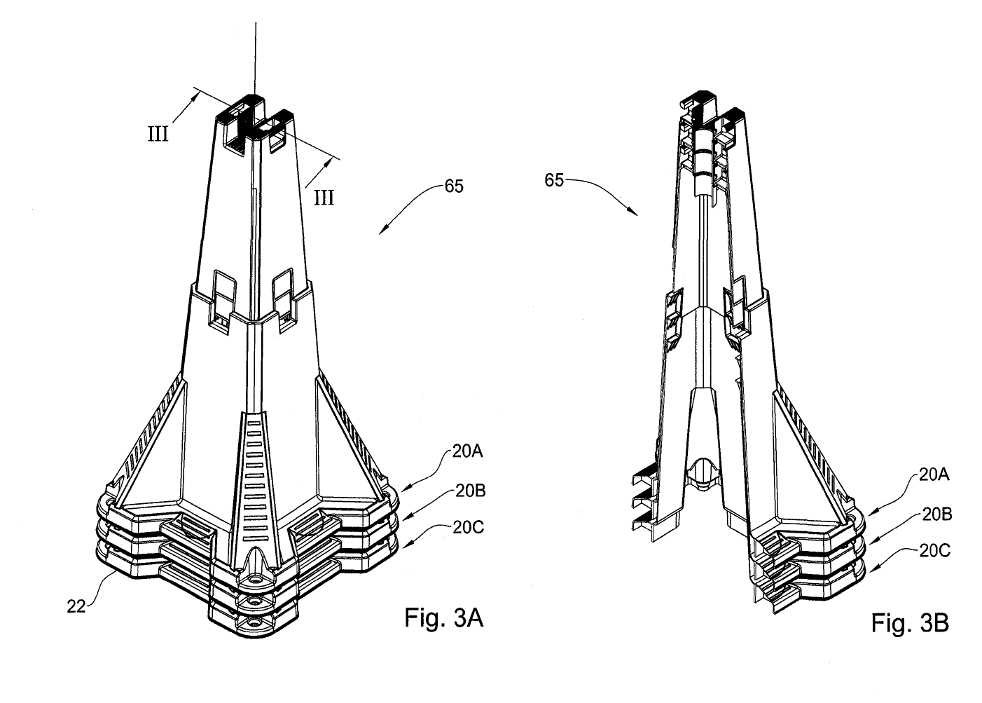

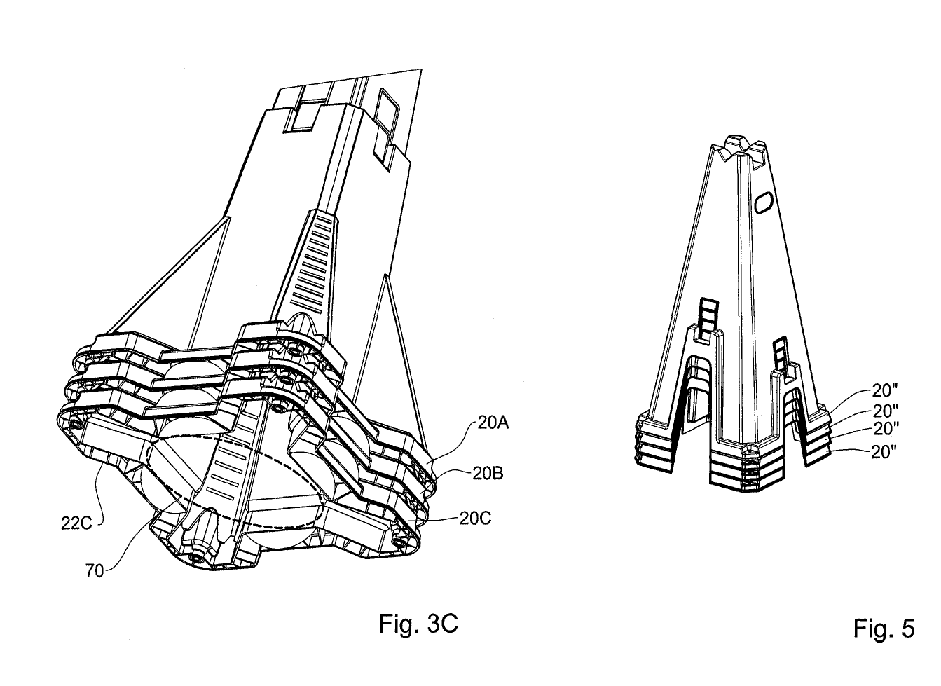

However, it is noted that the utility support 20, is nestable stackable over like utility supports 20, as will be illustrated herein after with reference to FIGS. 3A and 3B, thereby occupying a minimal footprint and minimal space.

As can further be seen, the utility support 20 comprises at the corners of the bottom base 22 holes 38 for securing the utility support 20 to a support surface, such as a ground surface, by bolts screws, etc. (not shown). Furthermore, the bottom base is configured with foot step portions 40 for supporting the utility support 20 and preventing its tilting e.g. during assembly of a beams thereto, as will be discussed hereinafter.

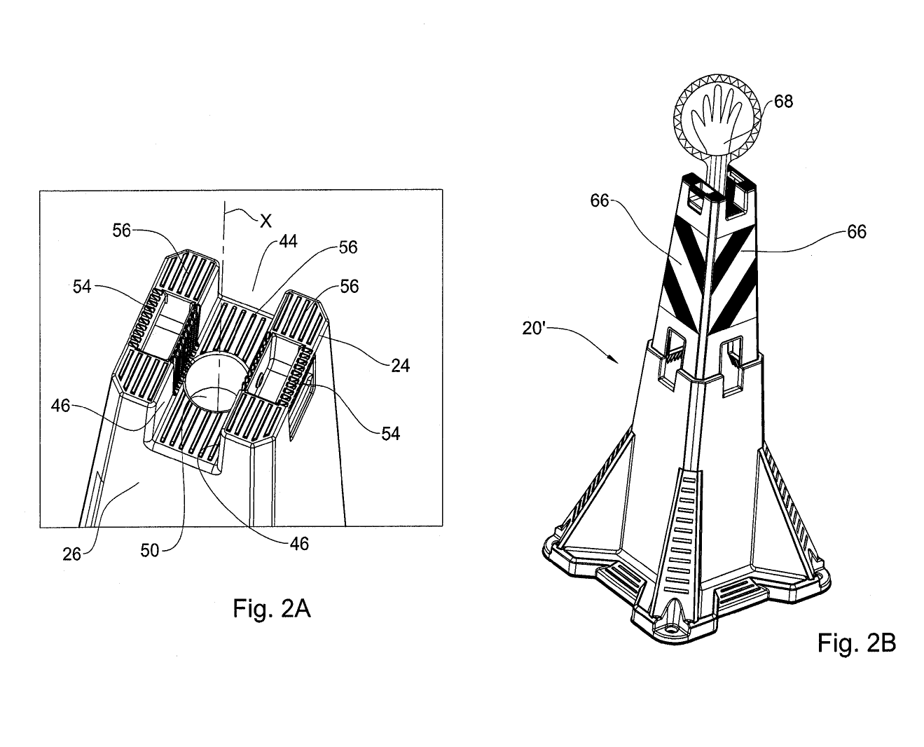

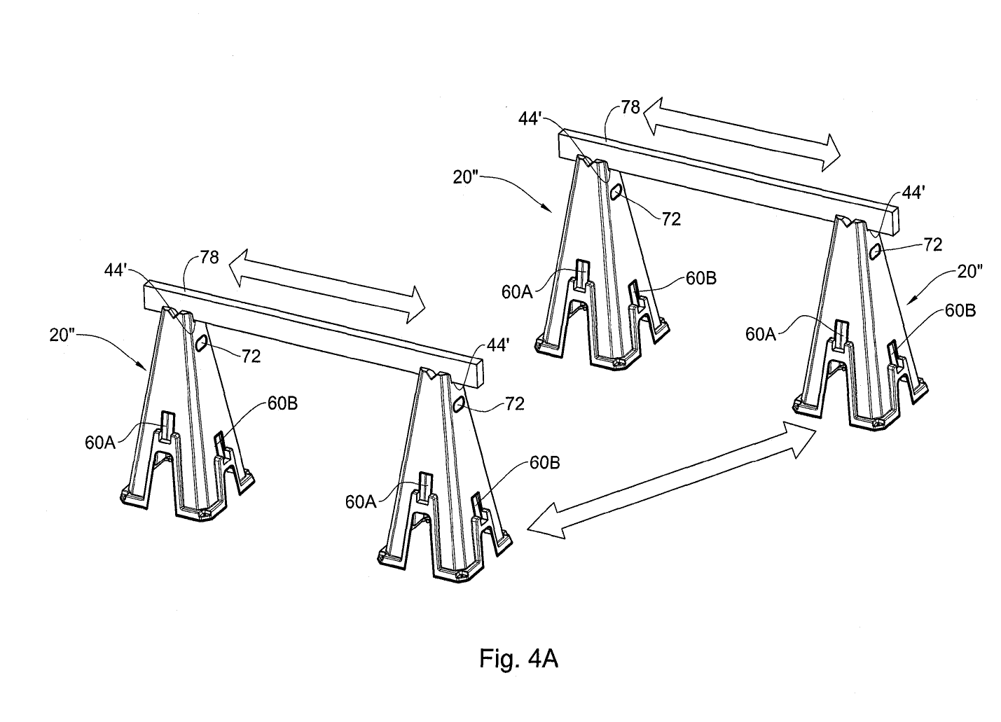

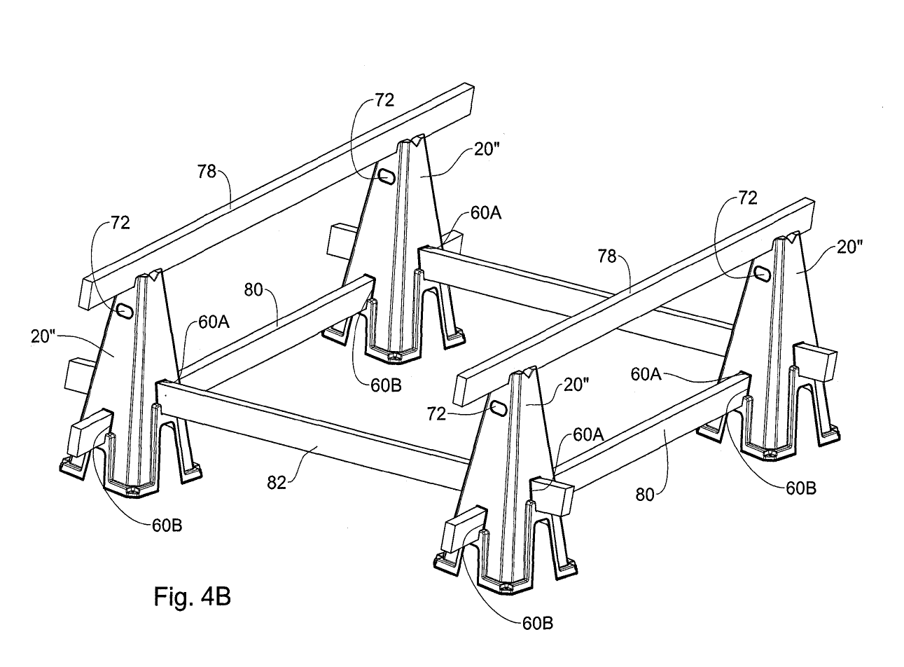

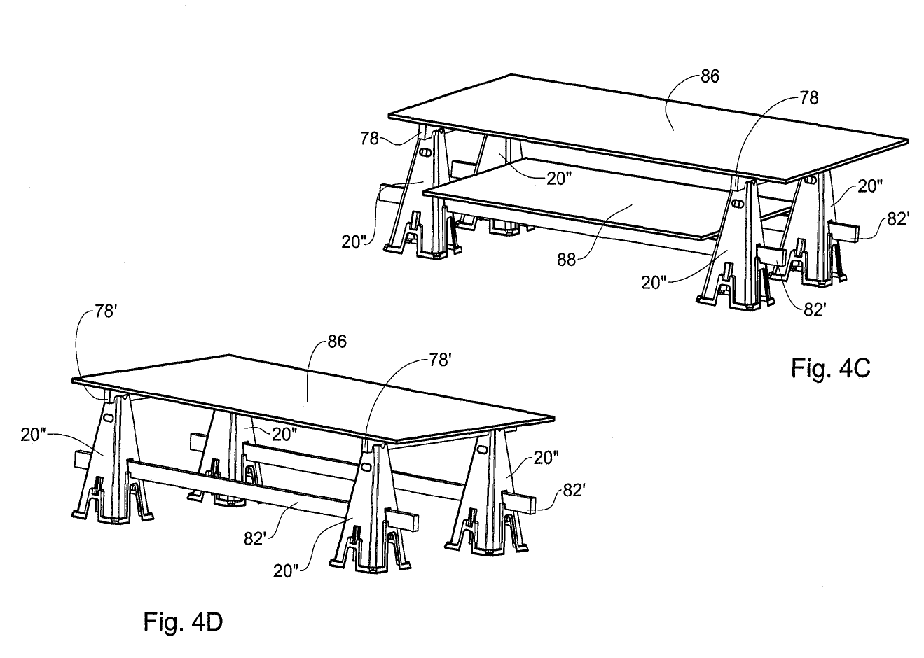

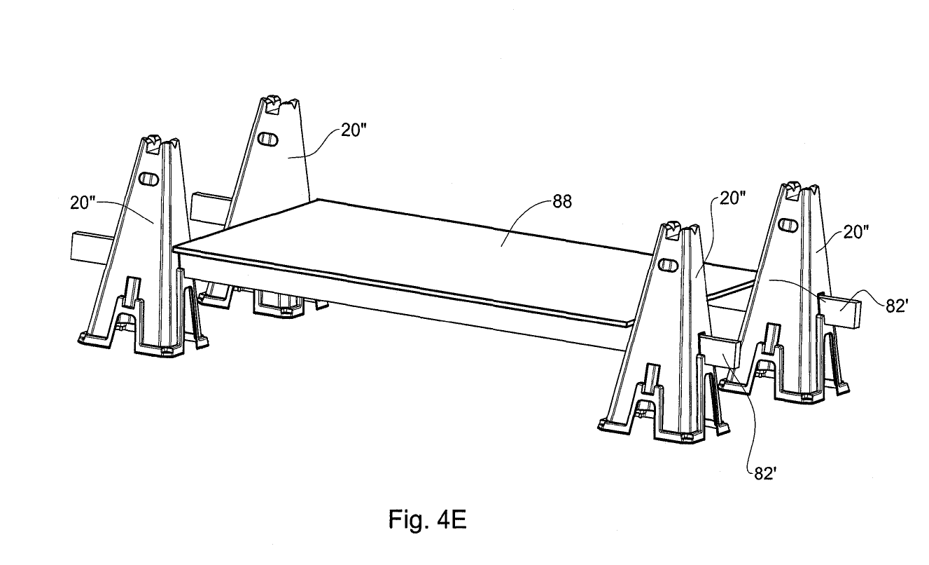

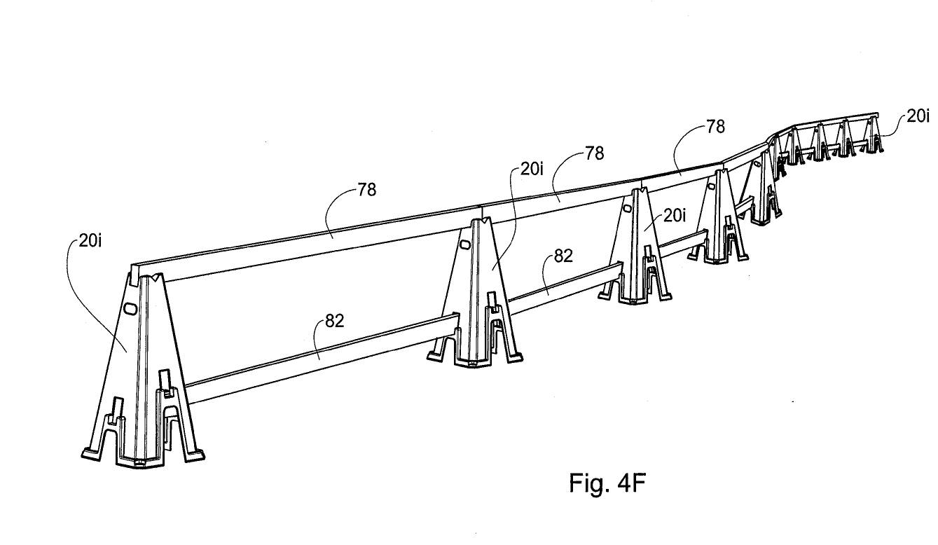

The top base 24 is configured with a first utility portion in the form of a substantially horizontally extending beam-support recess 44, intersecting the longitudinal axis X, and configured with substantially upright side walls 46 to thereby support a workpiece or a beam (FIG. 4) at an upright orientation. The top base 24 is further formed with another utility portions being a bore 50 (FIG. 2A) for vertically supporting a post such as a flag post, sign post, projector, hazard light, etc, (not shown). Also extending at the top base 24 are two tie loops 54 used for example for securing rods thereto, or hanging articles. As can be seen, top surfaces 56 of the top base are knurled or roughened, for improved grip of articles mounted thereon, and for anti-slip.

Further seen, the utility support 20 is configured with other utility portions in the form of four apertures 60, at the four respective faces of the utility support 20, each aperture 60 extending normal to the respective bearing side wall, and in the illustrated example also perpendicular to the longitudinal axis X, such that each two opposite apertures 60 coextend, whereby a bar can easily be introduced therein and supported at a substantially upright position, as will be exemplified hereinafter. It is appreciated that one or more apertures can be configured at different locations over the side walls.

In FIG. 2B there is illustrated a utility support 20′ similar to utility support 20 of FIG. 1, however with reflective portions 66 applied over side walls of the utility support, and a hazard light unit 68 fitted into the bore 50 at the top base 24. Such a utility support 20′ can serve as a traffic cone or hazard cone.

FIGS. 3A and 3B illustrate a stack 65 of several utility supports (three in the present example, designated 20A, 20B and 20C), nestable stackable over like utility supports 20, thereby occupying a minimal footprint and minimal space. It is seen that the stack occupies minimal height owing to the compact design facilitating that the utility supports practically adjoin each other.

According to a particular example, illustrated in FIG. 3C, an inside, bottom face of the bottom base 22C is configured with a container mounting portion designated 70, in the shape of a circular depression. This circular container mounting portion (actually an inscribed circle) is configured for mounting over a top edge, or a bottom edge, of a container, such as a utility 5-gallon container/bucket. This feature will become further apparent with reference to the further examples.

Turning now to FIGS. 4A to 4F, several examples of use of a utility support of the herein before discussed example are provided.

FIG. 4A shows four utility supports 20″, principally similar to utility supports 20, though with some differences. For example, utility supports 20″ are configured with carrying apertures 72 at a top portion thereof. Further, the utility supports 20″ are configured with utility portions, namely two pairs of opposite apertures 60A and 60B, the latter disposed lower that the former, such that bars can extend through the utility support at an intersecting orientation. This figure illustrates how the four utility supports 20″ are disposed in alignment such that a rectangular bar 78 is supported at the beam-support recess 44′. At a next position, illustrated in FIG. 4B, intersecting bars 80 and 82 are introduced into the apertures 60B and 60A, respectively, such that a closed ‘pen’ is defined, e.g. serving as a barrier surrounding an obstacle, etc.

FIGS. 4C, 4C and 4E illustrate how four are configured to erect together a base for a table (FIG. 4C) or work surface (FIG. 4D) and a low scaffold or bench (FIG. 4E). If required, the structure can be reinforced by fastening the table top board 86 or the bottom surface 88 to the beams 78′ 82′, respectively, and the beams can be secured to the utility support by tie bands secured to the loops 54 (see FIG. 1) or by screw fasteners and the like.

In FIG. 4F a series of utility supports 20, are disposed along a path with top bars 78 and bottom bars 82 extending between each two neighboring utility supports 20ᵢ, establishing a fence or barrier-like configuration.

FIG. 5 illustrates how a stack of four utility supports 20″, of the design illustrated in FIGS. 4A to 4F, are nestably stacked.

A second aspect of the present disclosure will now be described, with reference to the remaining drawings.

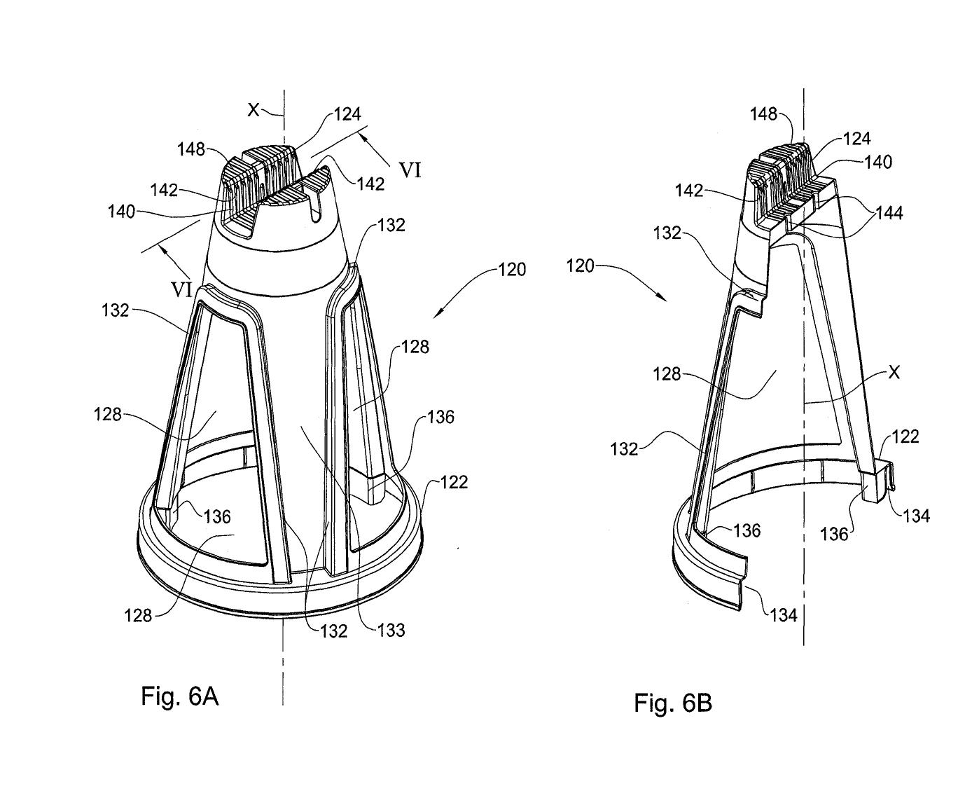

In FIGS. 6A and 6B there is illustrated a utility support generally designated 120 is configured with a bottom base 122 and a coaxially disposed top base 124 extending about a longitudinal axis X, with a tapering side wall imparting the utility support a frustoconical shape. It is noted that the side wall is configured with three substantially large openings 128, which on the one hand reduce weight of the utility support 120 and on the other hand function to admit access to a container, when used in conjunction therewith, as will be discussed herein after.

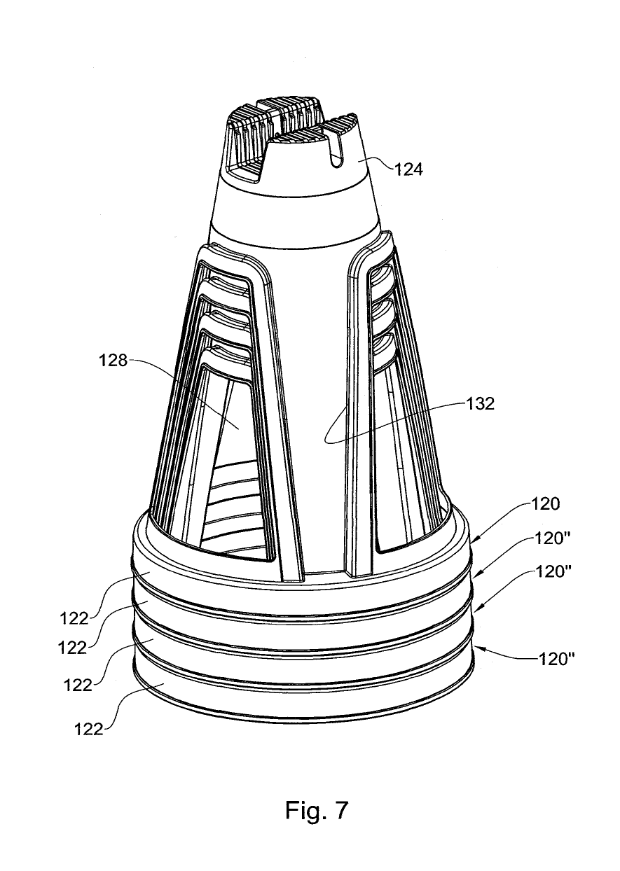

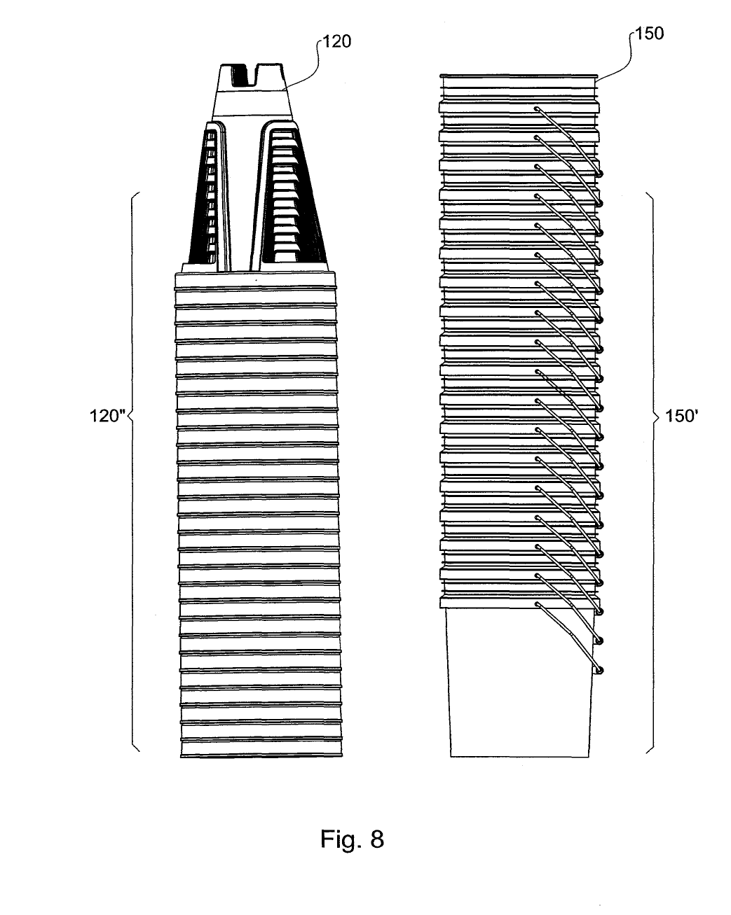

The structure of the utility support 120 is rigidified by reinforcing ribs 132 extending at least around portions of the openings 128, however not obstructing compact nestable stacking of the utility support 120 over like utility supports 120″, as illustrated in FIGS. 7 and 8.

As can be seen, best in FIG. 6B, the bottom base 122 is configured at a bottom face thereof with a circular container mounting portion 134, which in the present example is sized for mounting over a conventional 5-gallon container/bucket 150 (a stack 150′ of such containers in FIG. 8), of the type being in common use (at either an upright or a bottom-up orientation) and as will be discussed herein after in greater detail. As seen, downward extending portions 136 of side wall portions 133 extend into the container mounting portion 134, thereby providing for better grip over an edge of the container.

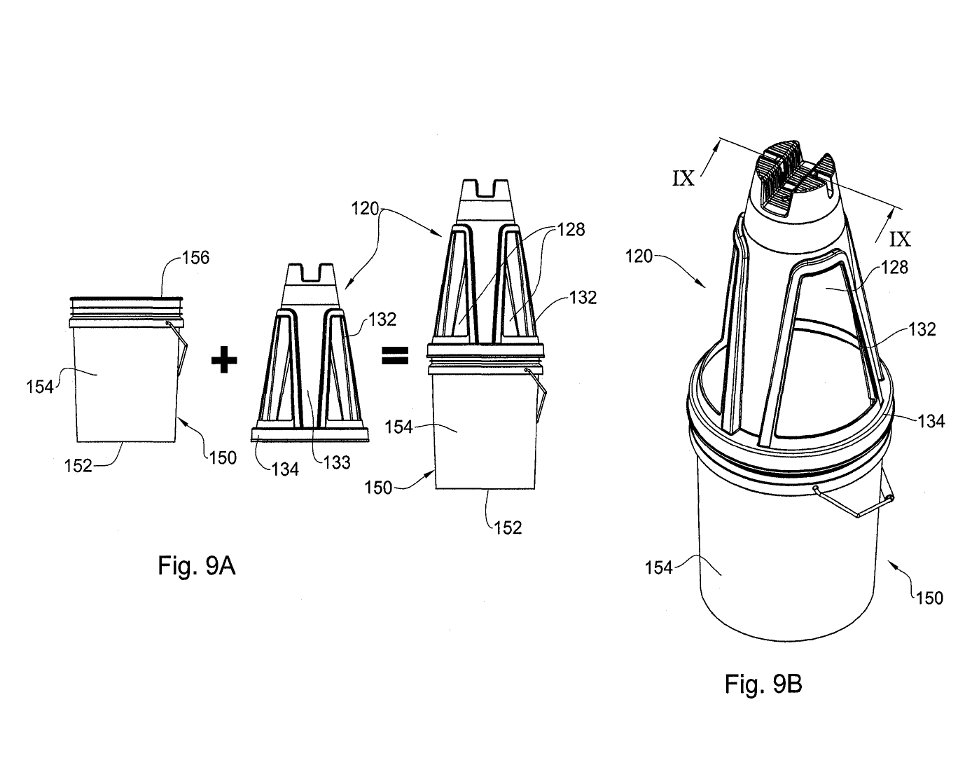

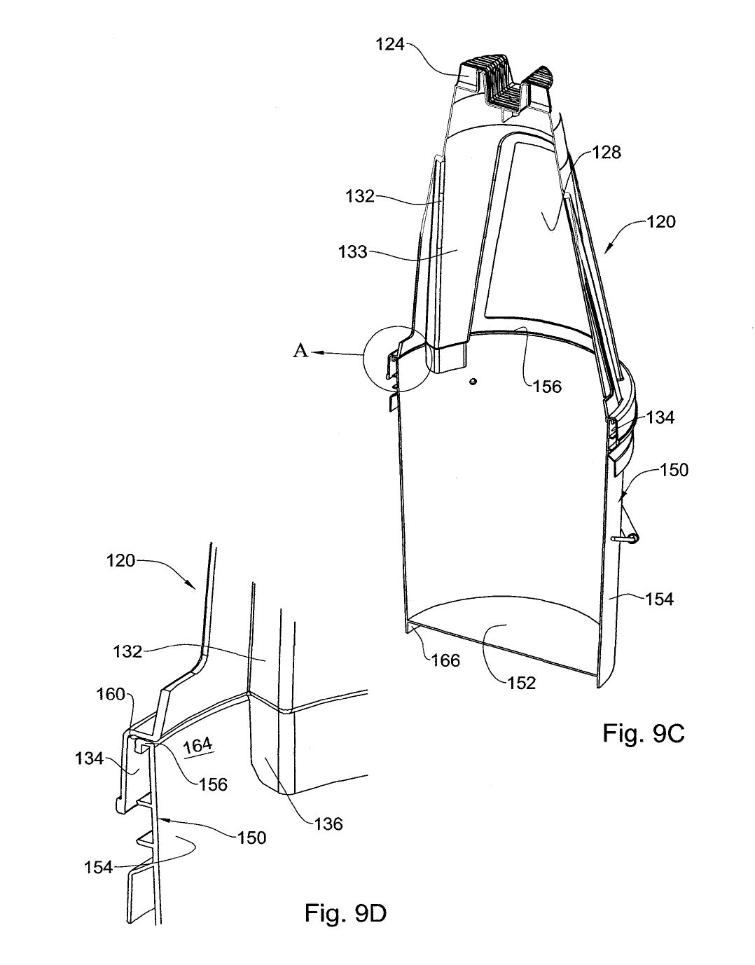

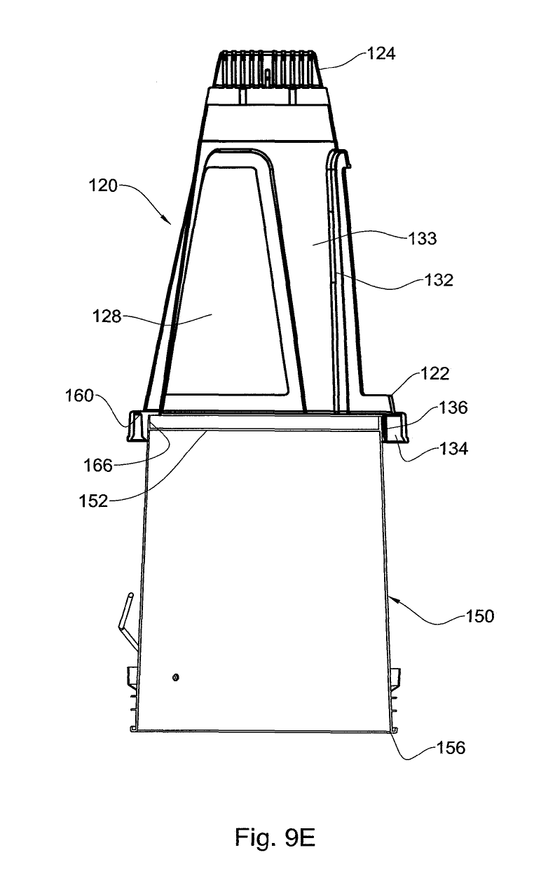

The top base 124 of the utility support 120 is configured with a utility portion in the form of a substantially horizontally extending beam-support recess 140 intersecting the longitudinal axis X, and configured with substantially upright side walls 142 to thereby support a workpiece or a beam (FIG. 9C) at an upright orientation. The top base 124 is further formed with fastener openings 144 e.g. for securing the beam to the utility support 120. Furthermore, top wall surfaces 148 of the top base and side wall surfaces of the beam-support recess 140 are knurled or roughened, for improved grip of articles mounted thereon, and for anti-slip.

With particular reference made to FIGS. 9A to 9D there is illustrated a 5-gallon container 150 configured with a base (best noted in FIG. 9C) and a side wall 154 extending to the top open edge 156. Whilst the description and drawings refer to a conventional 5-gallon container/bucket, it is understandable that any suitable container can be used in conjunction with the utility support subject of the present disclosure, as far as dimensions and shape, with corresponding changes in shape of the container mounting portion of the utility support, mutatis mutandis.

It is seen, best in FIGS. 9C and 9D that once the utility support 120 is mounted over the container 150, the container mounting portion 134 engages the top edge 156 of the container, where a bottom surface 160 of the container mounting portion 134 rests over the top edge 156 of the container, and wherein the downward extending portions 136 of side wall portions 133 bear against a top inside surface 162 of the container, whereby the utility support is stably mounted over the container 150.

The large openings 128 of the utility support 120 facilitate accessibility into the container 150 also upon assembly of the utility support over the container, thus maintain functionality of the container has a bucket, storage utility, etc, for keeping any goods, gear, fish or bate when fishing, etc.

As can be noted in FIG. 9C, the container 150 has an annular rim 166 projecting downwards from the base 152. This rim facilitates mounting of the utility support 120 over the container 150 also when the later is at an upside down position, i.e. with its opening facing downwards, as shown in FIG. 9E. It is noted however, that also at the absence of the annular rim 166 the utility support 120 can be mounted over an upside down positioned container.

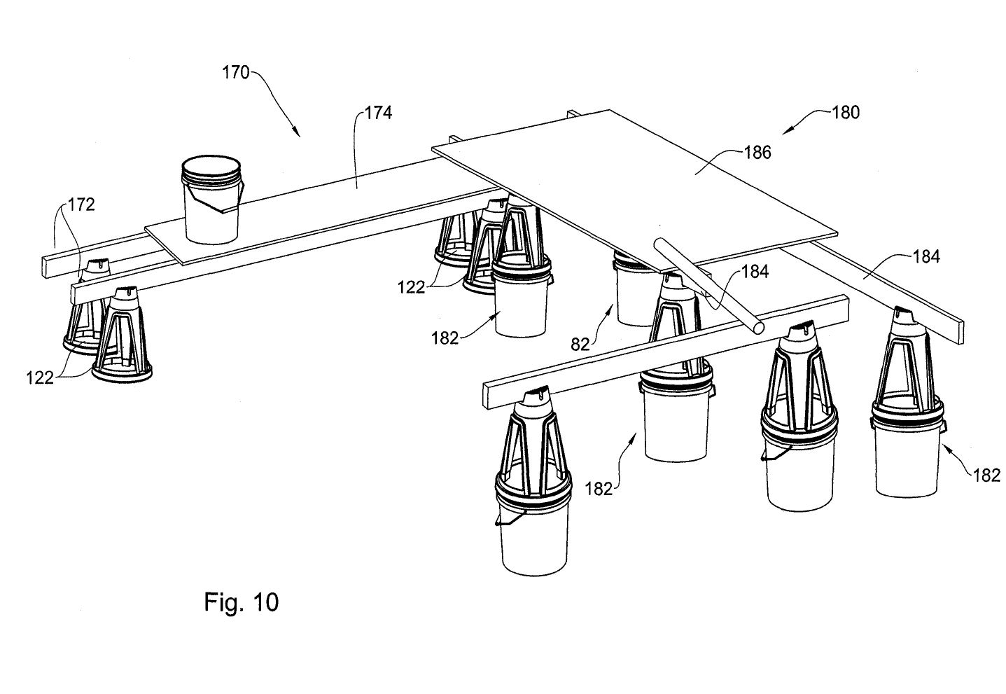

FIG. 10 illustrates several ways of employing a utility support of the type disclosed in connection with FIG. 6A. For example, a scaffold or low bench 170 is established by positioning two pairs of utility supports 120 in alignment, with a connecting beam 172 extending between each pair and applying a plywood board 174 thereover. A high work bench/table or scaffold 180 is erected by four assembled utility supports over buckets 182 (as in the example of FIGS. 9A to 9D) are positioned with connecting beams 184 extending between aligned assemblies 182 and a plywood board 186 mounted thereover.

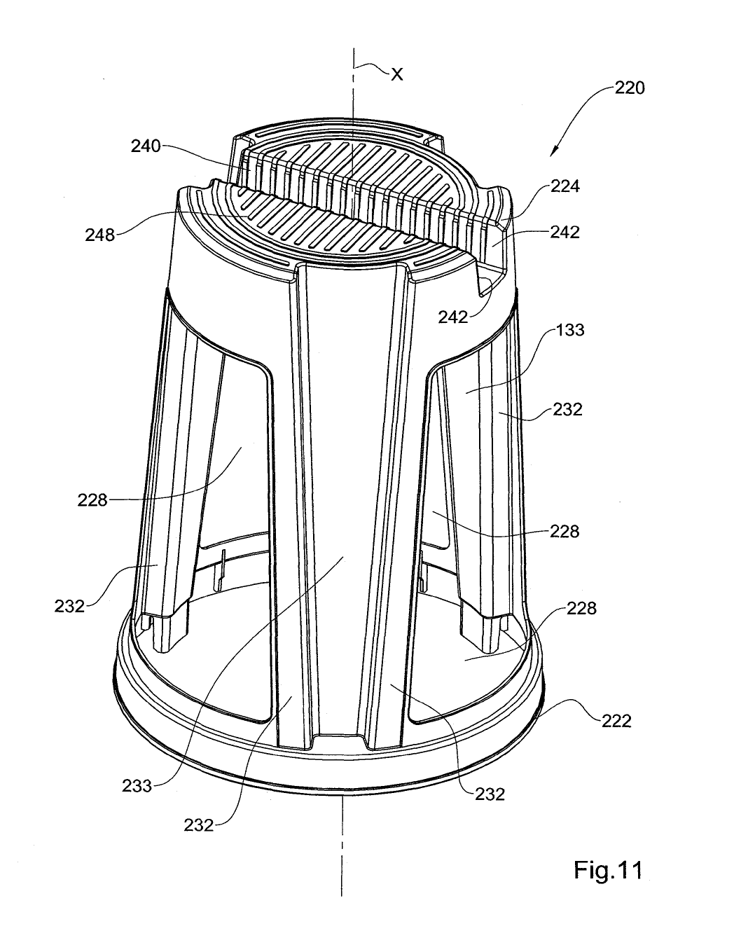

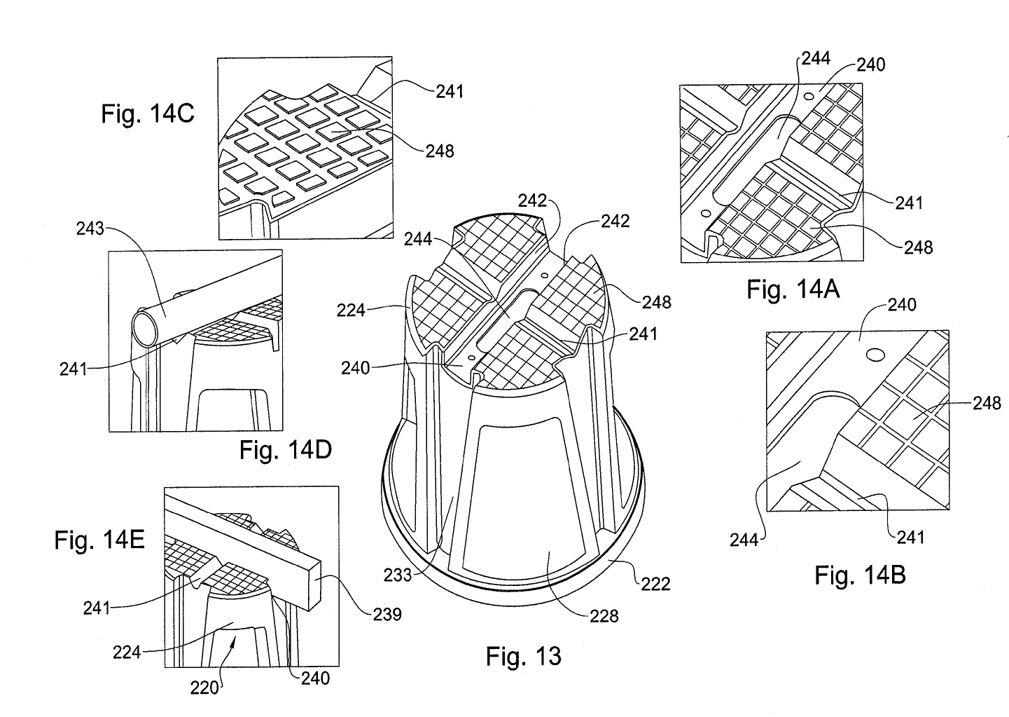

The drawings of FIGS. 11 to 15 are directed to a modification of the utility support disclosed in connection with the previous example, wherein like reference numbers are used for identifying like elements, however shifted by 100.

The utility support generally designated 220 is configured with a bottom base 222 and a coaxially disposed top base 224 extending about a longitudinal axis X, with a slightly tapering side wall 233. It is noted that the side wall 233 is configured with three substantially large openings 228, which on the one hand reduce weight of the utility support 220 and on the other hand function to admit access to a container, when used in conjunction therewith, as will be discussed herein after.

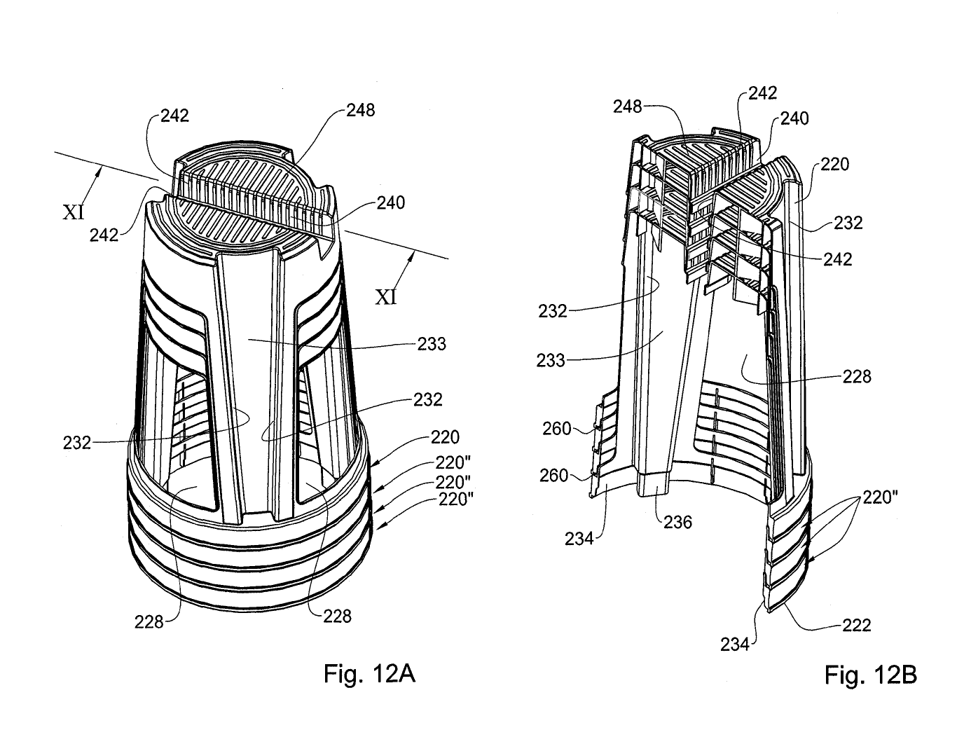

The structure of the utility support 220 is rigidified by reinforcing ribs 232 extending at least around portions of the openings 228, however not obstructing compact nestable stacking of the utility support 220 over like utility supports 220″, as illustrated in FIGS. 12A and 12B.

As can be seen, best in FIG. 12B, the bottom base 222 is configured at a bottom face thereof with a circular container mounting portion 234, which in the present example is sized for mounting over a conventional 5-gallon container/buck of either the utility support and the container/bucket, as will be exemplified herein after. As explained in greater detail with reference to FIG. 6B, downward extending portions 236 of side wall portions 233 extend into the container mounting portion 134, thereby providing for better grip over an edge of the container.

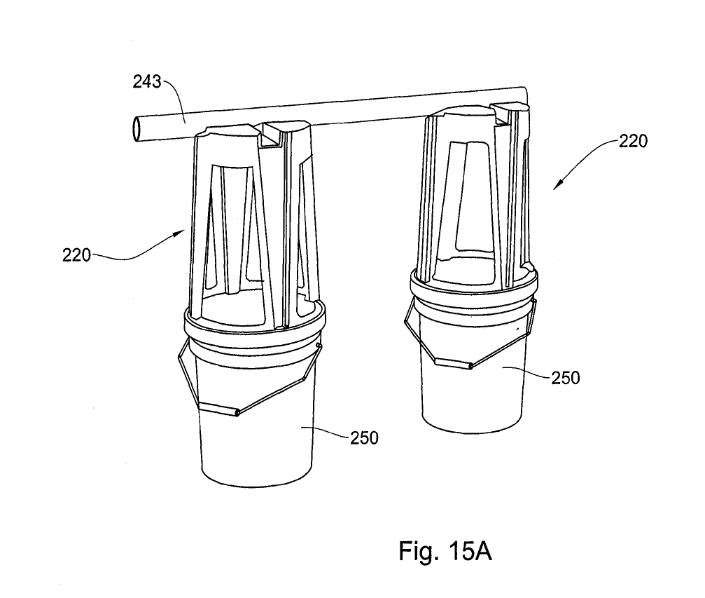

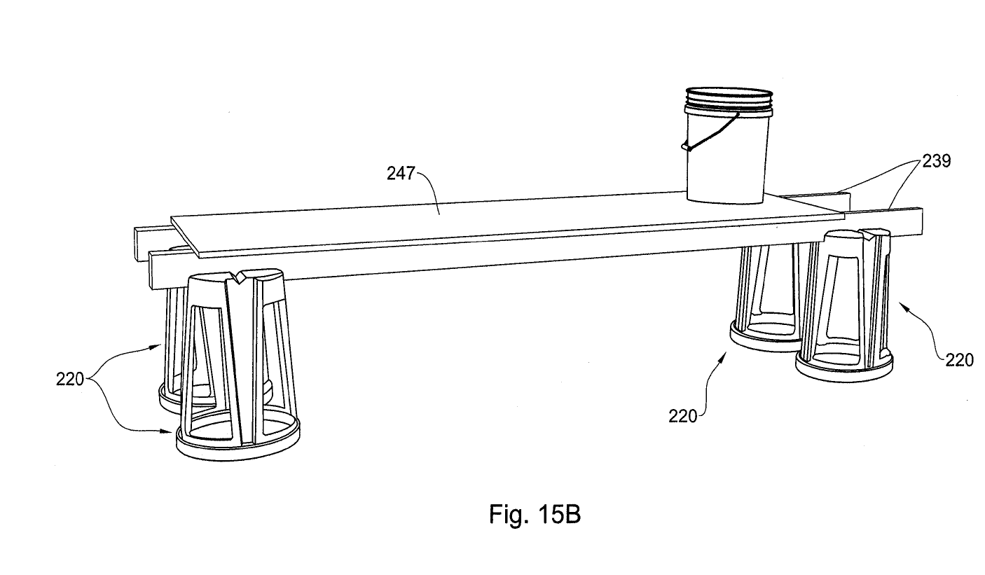

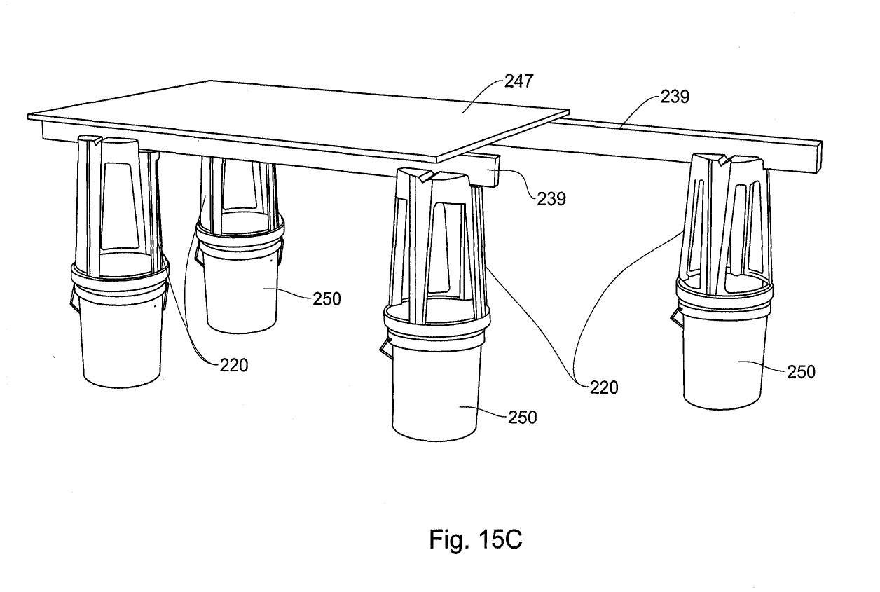

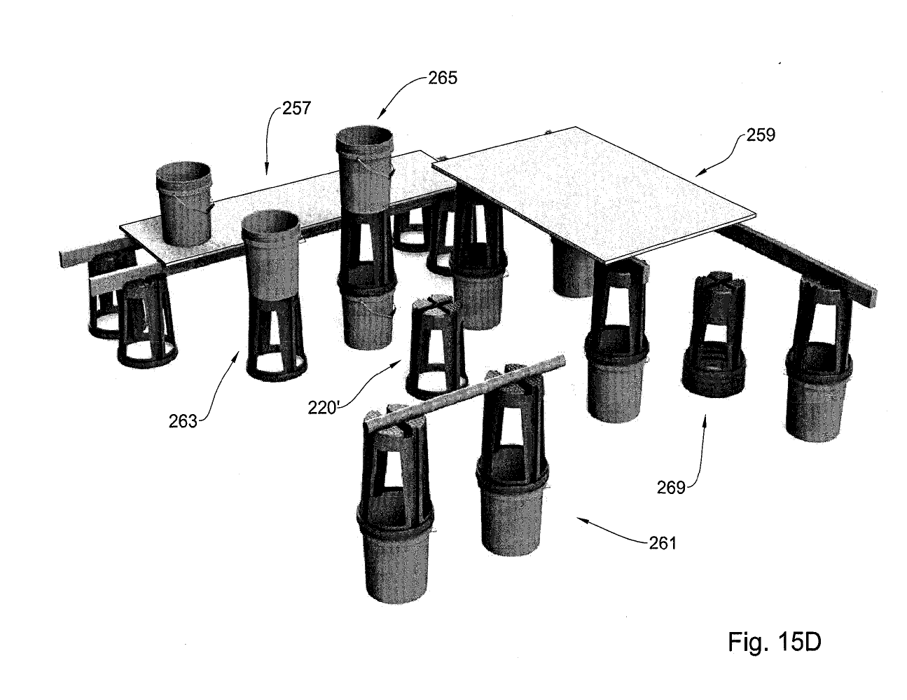

The top base 224 of the utility support 220 is configured with a utility portion in the form of a substantially horizontally extending beam-support recess 240 intersecting the longitudinal axis X, and configured with substantially upright side walls 242 to thereby support a beam 239 at an upright orientation (FIG. 14E). According to a particular example, the top base 224 is further configured with a V-notch 241 (intersecting beam-support recess 240) for supporting a round workpiece 243 (FIGS. 14E and 15A).

The top base 224 is further formed with a top opening 244 for carrying the utility support 220. Furthermore, top wall surfaces 248 of the top base and side wall surfaces of the beam-support recess 240 are knurled or roughened, for improved grip of articles mounted thereon, and for anti-slip. The size of the top base 224 renders it useful as a seating surface, so it can serve as a stool.

As previously explained herein, once the utility support 220 is mounted over a container 250, the container mounting portion 234 engages the top edge of the container, where a bottom surface 260 of the container mounting portion 234 rests over the top edge 156 of the container (see FIG. 9D), and wherein the downward extending portions 236 of side wall portions 233 bear against a top inside surface of the container, whereby the utility support is stably mounted over the container 250.

The large openings 228 of the utility support 220 facilitate accessibility into the container 250 also upon assembly of the utility support over the container, thus maintain functionality of the container has a bucket, storage utility, etc, for keeping any goods, gear, fish or bate when fishing, etc.

Similar to the previous example, the utility support 220 can be mounted over a container also when the later is at an upside down position, i.e. with its opening facing downwards.

With particular reference made to FIGS. 15A to 15D there are illustrated several ways of use if the utility support 220 in conjunction with a container (5-gallon containers 250 used in the examples).

In FIG. 15A a pair of utility supports 220 are each mounted over a container 250 with the V-notches 241 aligned, thus serving as a saw horse or work bench for a pipe 243.

In FIG. 15B four utility supports 220 are positioned on the ground, each pair with its respective beam-support recess 240 in alignment and supporting a rectangular wood beam 239, and a plywood board 247 mounted thereon, serving as a work bench, scaffold, etc.

In FIG. 15C four utility support2 220 are assembled over four corresponding containers, as explained herein above, assembling an elevated support structure, wherein the beam-support recess 240 are in alignment, supporting rectangular wood beams 239, and a plywood board 247 mounted thereon, serving as an elevated work bench, scaffold, etc.

FIG. 15D represents a work arena, illustrating a low scaffold assembly generally designated 257 (similar to the construction of FIG. 15B), and an elevated scaffold, or elevated work surface generally designated 259. Also illustrated is a utility support 220′ serving as a seat/stool, and a pair of elevated utility supports 261 serving as a saw horse or work bench for a pipe 243 (as in FIG. 15A). The assembly generally designated 263 is bucket disposed over a utility support at an elevated position, and the assembly designated 265 is a three-level assembly with the bucket disposed at the top. A of utility supports is designated 269.

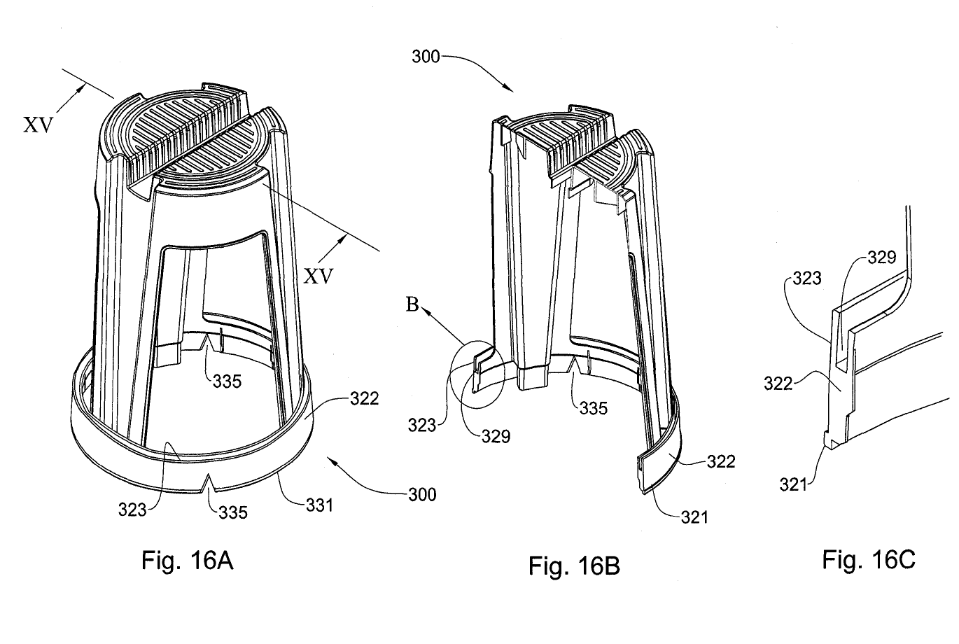

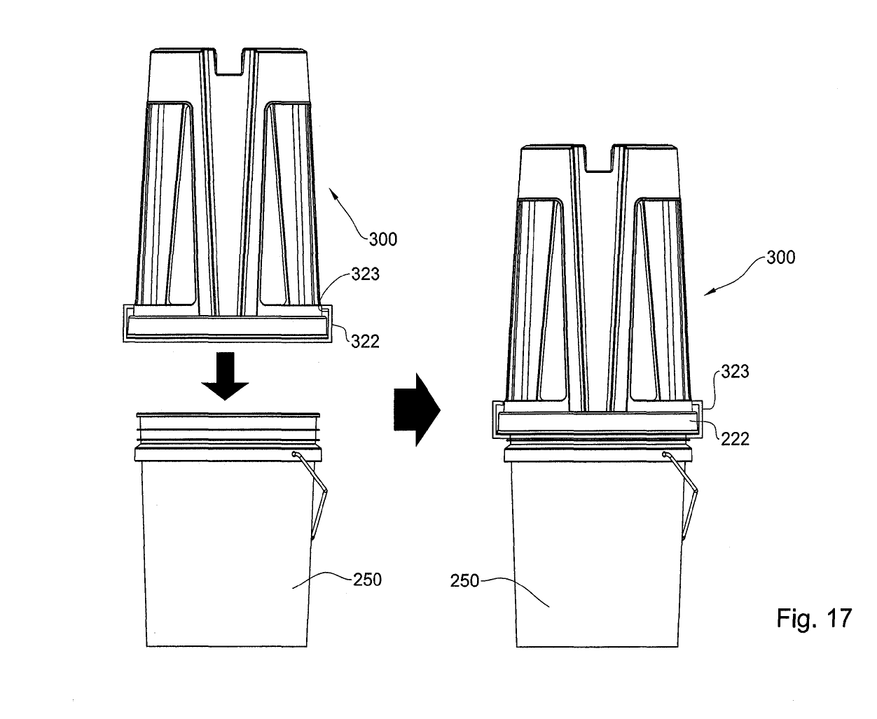

A further example of a utility support according to the present disclosure will now be discussed with reference to FIGS. 16 to 19.

The utility support generally designated 300 is identical to utility support 220 of the previous example and reference is made back thereto, whereby like elements are designated with like reference numbers, however shifted by 100.

The utility supports 220 and 300 are similar however with the exception that the utility support 300 is further configured at the bottom base thereof 322 with an upwardly extending annular rim 323 giving rise to an annular groove 329 constituting an alternative container mounting portion.

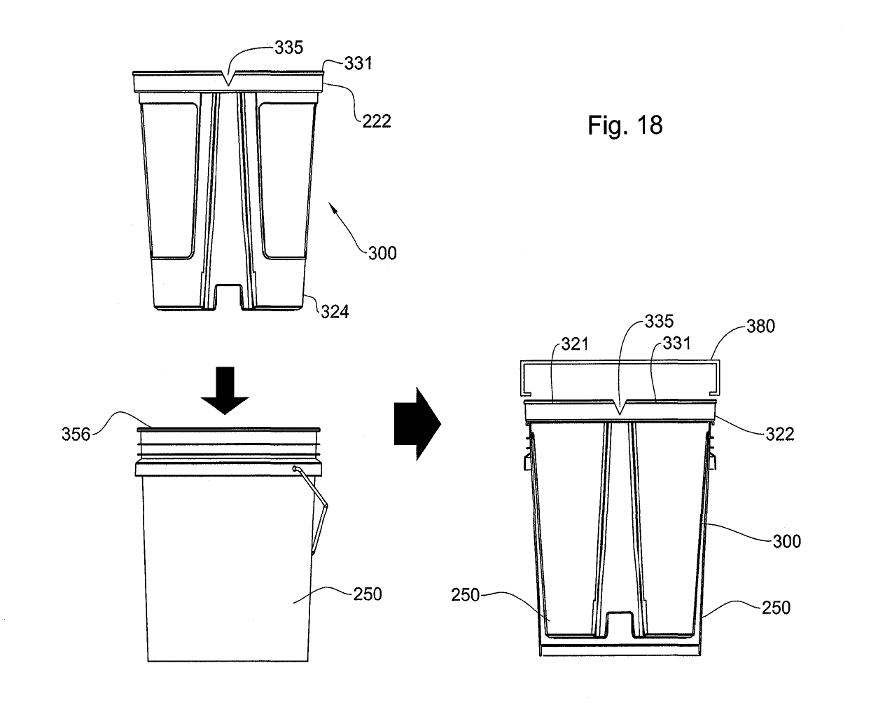

It is further seen that the bottom edge 321 of the bottom base 322 is configured with two V-notches 335 extending opposite one another. These are useful in a second mounting position as will be shown with reference to FIG. 18.

The alternative container mounting portion renders the utility support 300 suitable for mounting over a container 250 at either an upright position as illustrated in FIG. 17 and as described herein before in connection with the previous example, or at an inverted, bottom-up position, as illustrated in FIG. 18. At the bottom-up position the utility support 300 is mounted with its top base 324 facing downwards and further wherein a majority of the utility support 300 is received within the container 250, with the bottom edge 331 facing upwards. At this position the top edge 356 of the container 250 bears within the annular groove 329 of the utility support 300, and wherein the V-notch 335 projects above the top edge of the container 259, rendering for use as a pipe cutting grip etc.

It is further noted that the diameter of the bottom edge 331 and the shape of the bottom rim are suited for engaging with a cover 380 (FIG. 18) whereby the contents of the container is secure and where the cover 380 can serve as a seat.

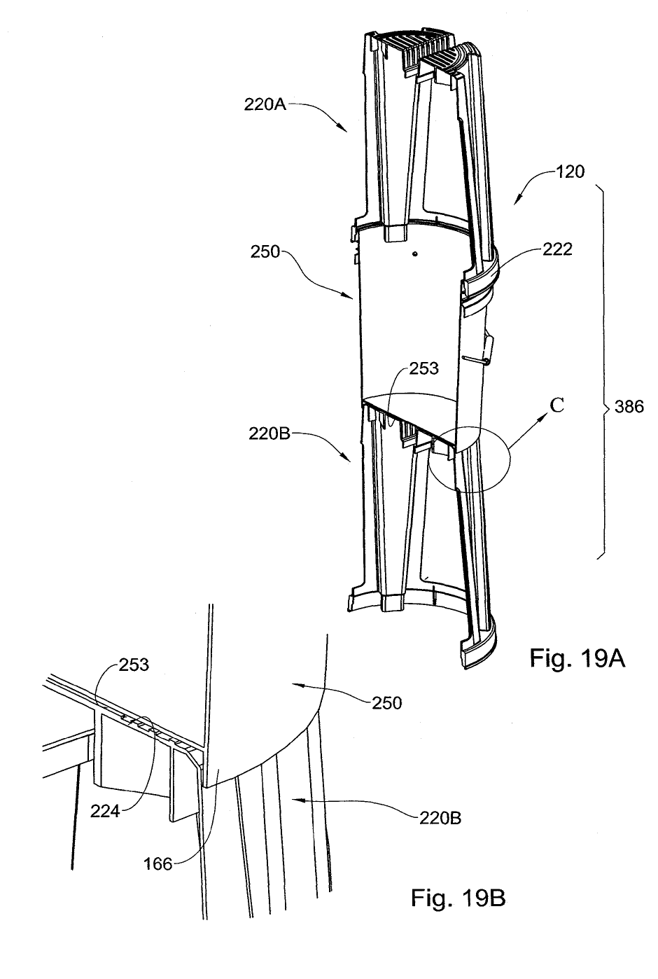

The assembly 386 illustrated in FIGS. 19A and 19B presents two utility supports 220A and 220B (of the kind disclosed herein before, for example with reference to FIG. 11) and a container 250 (e.g. a 5-gallon bucket), whereby the container 250 is mounted over the bottom utility support 220B, the later at its upright position such that a bottom face 253 of the container 250 rests over a top base 224 of the bottom utility support 220B, wherein a downward annular rim 166 of the container 250 envelopes a top portion of the top base 224. The top utility support 220A is also mounted at its upright position such that its bottom base 222 rests over the top edge of the container 250 (similar to the arrangement disclosed in FIGS. 9C and 9D). This arrangement gives rise to a three-level utility support useful in a variety of ways as exemplified herein before.

1. A utility support comprising a bottom base with a tapering side wall extending therefrom towards a top base, wherein said utility support is hollow and configured for nestable stacking over like utility supports, and further wherein at least one of said side wall, said bottom base and said top base is configured with at least one utility portion.

2. The utility support according to claim 1, wherein the bottom base of said utility support is configured with side walls extending therefrom, whereby the bottom base of the utility support is configured for mounting over an edge of a container.

3. The utility support according to claim 1, wherein the utility support is a configured for use at a stand-alone configuration, with the bottom base supported on a ground surface.

4. (canceled)

5. The utility support according to claim 1, wherein the bottom base and the top base are coaxial along a longitudinal axis of the utility support.

6. The utility support according to claim 1, wherein at least one of the bottom base and the top base is polygonal or circular.

7. (canceled)

8. The utility support according to claim 1, wherein the tapering side wall is continuous or interrupted, with one or more apertures at least over a portion of the wall.

9. The utility support according to claim 1, wherein the tapering side wall is solid or is defined by side posts extending between said bottom base and said top base.

10. The utility support according to claim 9, wherein the side walls and the side posts are configured with reinforcing ribs or longitudinally extending bends, thus increasing yield strength of the utility support, at least in the axial direction along the longitudinal axis.

11. The utility support according to claim 9, wherein the side walls and the side posts are configured with longitudinally extending bends having a bottom end and an open top end, said top end being wider than said bottom end.

12. The utility support according to claim 1, wherein the utility support is made of molded plastic material.

13. The utility support according to claim 1, wherein the bottom base is a continuous surface or an interrupted surface with one or more openings.

14. The utility support according to claim 1, wherein the utility portion is a notch.

15. The utility support according to claim 1, wherein the utility portion is a beam support, whereby one or more beams or rods are connected to or extend from the utility support, optionally wherein aid beam support extends on the top base and/or through side walls.

16. (canceled)

17. The utility support according to claim 1, wherein the utility portion is selected from the group consisting of a pole support and a traffic cone with or without signs.

18. (canceled)

19. The utility support according to claim 1, wherein the utility portion is configured (i) for articulation thereto of one or more beams by fasteners, (ii) with a clamp coupling portion for clamping articles thereto, (iii) with one or more, optionally closable, compartments, and/or (iv) with a fixing arrangement at the bottom base of the utility support, for securing same to a top edge of a container.

20. (canceled)

21. The utility support according to claim 1, wherein the utility portion is a seating surface configured at the top base.

22. (canceled)

23. (canceled)

24. The utility support according to claim 1, wherein when used in conjunction with a container or a bucket, with the bottom base being mounted over the top edge of said container or said bucket, openings at the side wall of the utility support facilitate accessibility into the interior of the container or the bucket.

25. The utility support according to claim 1, wherein the bottom base is configured with a dual position mounting portion, configured for mounting the utility support over a top edge of a container/bucket at an upright position, i.e. with the top base extending above the bottom base, or at the bottom-up position with the top base extending into the interior of the container/bucket (below the bottom base), optionally wherein the dual position mounting portion of the bottom base has a T-like cross-section.

26. (canceled)

27. The utility support according to claim 1, wherein when disposed at the bottom-up position a cover is articulated over a bottom edge of the bottom base, thereby serving as a cover for the container and optionally as a seat.

28. The utility support according to claim 1, wherein the bottom edge of the bottom base is configured with notches there facilitating it for use as a saw horse.
